(19) United States
(12) Patent Application Publication
(10) Pub. No.: US 2009/0325739 A1
(43) Pub. Date: Dec. 31, 2009

(54) INTELLIGENT BASKETBALL

(76) Inventor: Robert S. Gold, Newburgh, IN (US)

Correspondence Address: C RICHARD MARTIN;MARTIN & MARTIN, ATTORNEYS AT LAW, PC, PO BOX 29, BOONVILLE, IN, 47601, US

(21) Appl. No.: 12/146,348

(22) Filed: Jun. 25, 2008

(51) Int. Cl. A63B 43/00; G06F 19/00

(52) U.S. Cl. 473/570; 700/91

(57) ABSTRACT

A device for providing information concerning position and movement of a ball, in particular a basketball, to a user is provided. The device includes a ball having an opening therein. A sensor board is positioned within the opening in the ball. The sensor board carries a three-axis accelerometer electrically connected to a microcontroller and a transceiver. A receiver board is also provided and is located remotely from the ball. The receiver board carries a transceiver electrically connected to a microcontroller and a plug for connecting to a personal computer. The accelerometer on the sensor board continuously senses the position and acceleration of the ball. That information is then transmitted wirelessly to the receiving board by the transceivers. The position and acceleration information is then integrated in order to calculate the end position of the ball based on the position and acceleration information and previously input data on the shooter's height, distance from the basket and height of the basket. The data is then transferred to a personal computer by a USB connection for display to the shooter.

### FIELD OF THE INVENTION

The invention relates to a sports implement such as a ball, preferably a basketball, that provides information to a basketball player about the nature of his or her shot, specifically, the velocity and angle of each shot.

### BACKGROUND OF THE INVENTION

Basketball shooting percentages have been flat or decreasing at all levels of competition. For example, the National Basketball Association average free throw shooting percentage has been constant at around 74% since 1958. Nearly one-third of all NBA players shoot less than 70% from the free throw line. It is difficult to think of a performance statistic in any other sport that has shown no improvement in the last 45 years.

Most shots miss because they are too short or too long. Distance of a shot is controlled by arc and shooters at all levels have great difficulty controlling the arc of their shots. Arc is the path the basketball flies from the time it leaves the shooter's hand until it arrives at the basket. Once in the air, gravity is the only force affecting the ball, so the flight is completely predictable for a given release direction, release point and release strength.

Using mathematical modeling, it is possible to make a shot such as a free throw every time. As shown in FIGS. 1 & 2, the relevant constant factors are the height of the shooter h1, the height of the basket h2 (usually 10 feet), and the distance, d, from the shooter to the basket. Given these factors, for a given shooter, mathematical modeling, such as is discussed in Modeling Basketball Free Throws by Joerg M. Gablonsky and Andrew S. I. D. Lang, SIAM Review, Vol. 47, No. 4, pp. 775-798 (2005), can suggest the optimal release angle and velocity necessary to make the shot.

However, knowing the proper angle and release velocity needed is only half of the story. To truly make progress and change the shot to make it every time, a shooter needs a way to measure the release angle and velocity of his or her shot. Prior to the present invention, the release angle, trajectory and arc could be measured only by utilizing sophisticated video equipment that would allow the shot to be photographed or videoed. With the assistance of a computer and software, the path of the ball could be traced and the release angle and arc determined. The speed of the ball could also be determined by review of the video. Such systems, however, are expensive, cumbersome, and do not provide immediate feedback to the shooter.

On Jun. 26, 2007 a prototype of this invention was successfully demonstrated by engineers from Freescale Semiconductor at the Freescale Technology Forum Americas in Orlando, Fla. The components that have been utilized to make the intelligent basketball commercially viable are provided by Freescale Semiconductor, and include a three-axis accelerometer, a Zigbee transceiver, and an eight-bit microcontroller.

### SUMMARY OF THE INVENTION

Accordingly, there is a need for a basketball that could provide information to prospective players about the nature of their shooting—specifically, the velocity and angle of each shot. The present invention fulfills this need by incorporating a thee-axis accelerometer, a transceiver and a microcontroller, of the type known as the ZSTAR and manufactured by Freescale Semiconductor and described in a publication entitled Wireless Sensing Triple Axis Reference Design Designer Reference Manual. During operation, the ball's accelerometer senses acceleration and then uses the microcontroller to integrate the area under the acceleration curve. It therefore calculates velocity and then employs the transceiver to send the output to a nearby laptop computer to display the results. By understanding how an accelerometer is oriented inside the basketball, we can determine the initial release angle. Using software to extract the acceleration due to motion, we can integrate the acceleration values to approximate velocity.

With the use of these three components, the basketball can help a player improve their shot by providing feedback information on the velocity and angle of their shooting.

Utilizing Spalding's INFUSION technology, such as that described in United States Patent Application Publication No. US2002/0187866 A1, a basketball was outfitted to receive a sensor board containing the accelerometer, microcontroller and RF transceiver. The ball was then calibrated based on the location of the sensor board within the ball volume.

According to one aspect of the present invention a device for providing information concerning position and movement of a sports implement, such as a basketball, to a user is contemplated. The device may include a sports implement having an opening therein; means for sensing the position and acceleration of the sports implement, said sensing means positioned within the opening in the sports implement; means for transmitting position and acceleration information from the sensing means, said transmitting means positioned within the opening in the sports implement; means for receiving the position and acceleration information from the transmitting means, said receiving means located at a position remote to the sports implement; means for integrating the position and acceleration information to approximate velocity and for calculating the end position of the sports implement based on said position and acceleration information; and means for displaying said calculated data. The sensing means and transmitting means are preferably positioned on a sensor board. The sensing means comprises a 3-axis low-g accelerometer. The accelerometer has a selectable range of between 1.5 g and 6 g and is electrically connected to a microprocessor positioned on the sensor board. The microprocessor is an 8-bit microprocessor. The transmitting means and receiving means each comprise a short range, low power RF transceiver. The RF transceivers are 2.4 GHz ISM band transceivers. The integrating means comprises a microcontroller electrically connected to the receiving means RF transceiver. The microcontroller is electrically connected to a plug, such as a USB “A” type plug, which can be connected to a laptop or desktop personal computer.

According to another aspect of the invention, a device for providing information concerning position and movement of a ball to a user is provided. The device comprises a ball having an opening therein; a sensor board positioned within the opening in the ball, said sensor board comprising a three-axis accelerometer electrically connected to a microcontroller and a transceiver; a receiver board located remotely from the ball, said receiver board comprising transceiver electrically connected to a microcontroller and a plug, such as a USB “A” type plug, for connecting to a personal computer. The accelerometer has a selectable range of between 1.5 g and 6 g. The microprocessor is an 8-bit microprocessor. The receiver board transceiver and the sensor board transceiver each comprise a short range, low power RF 2.4 Ghz ISM band transceiver.

According to yet a further aspect of the present invention, a method of providing information to the user of a basketball is provided. The height of the shooter, distance from the basket, and height of the basket are input into a personal computer. All three xyz acceleration values are constantly measured by a three-axis accelerometer positioned on a sensor board located within an opening in the basketball. Said xyz acceleration measurements are sent from the accelerometer to a microcontroller that is electrically connected to the accelerometer and positioned on the sensor board. A data frame is then composed using simple RF protocol, and using simple media access controller is sent to a receiving board located remotely from the basketball over an RF link via an RF transceiver electrically connected to the microcontroller and positioned on the sensor board. The data is then received via an RF transceiver positioned on the receiving board. The data is then transmitted to a personal computer via a plug on the receiving board that is removably connected to said personal computer. Finally, the data is decoded and the user is provided with information about his or her shot.

These and other objects, features and advantages of the present invention will become apparent with reference to the text and the drawings of this application.

### BRIEF DESCRIPTION OF THE DRAWINGS

FIG. 1 is a diagrammatic representation in perspective of a shooter positioned to shoot a basketball at a basket.

FIG. 2 is a diagrammatic representation in perspective of a shooter positioned to shoot a basketball at a basket with various arc shown depicting different release angles and velocities.

FIG. 3 is a side view in elevation of the apparatus of the present invention.

FIG. 4 is a side view in elevation of the sensor board of the apparatus of the present invention.

FIG. 5 is a block diagram of the sensor board of the apparatus of the present invention.

FIG. 6 is a block diagram showing the operation of the components of the sensor board and the software.

FIG. 7 is a side view in elevation of the receiver board of the apparatus of the present invention.

FIG. 8 is a block diagram of the receiver board of the apparatus of the present invention.

FIG. 9 is a block diagram showing the operation of the components of the receiver board and the software.

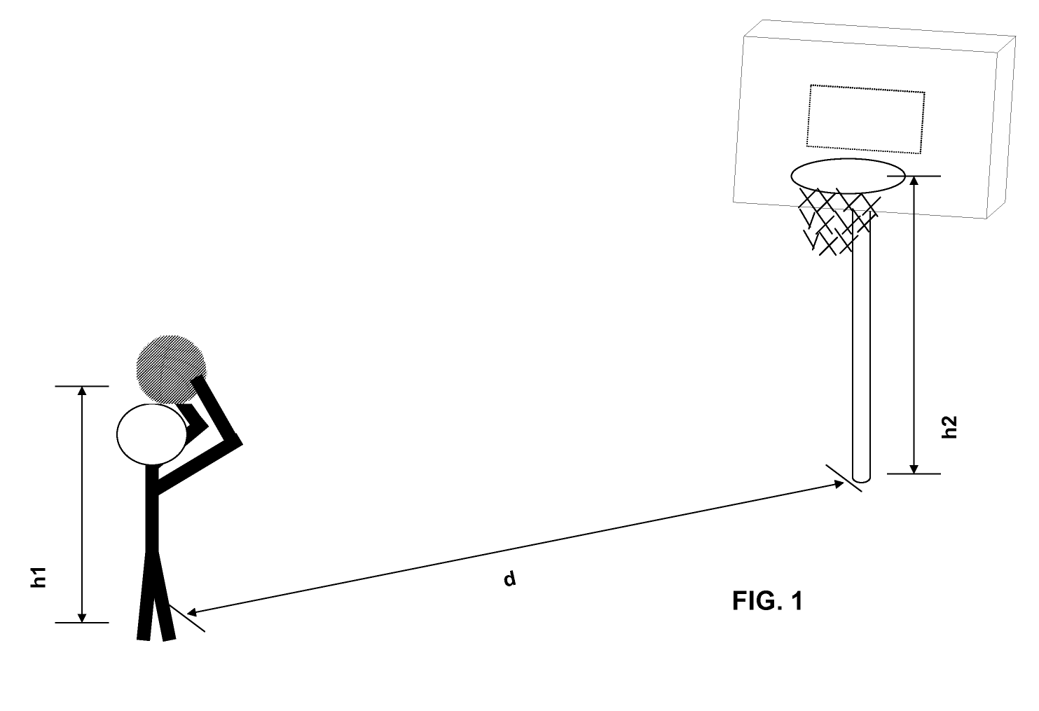

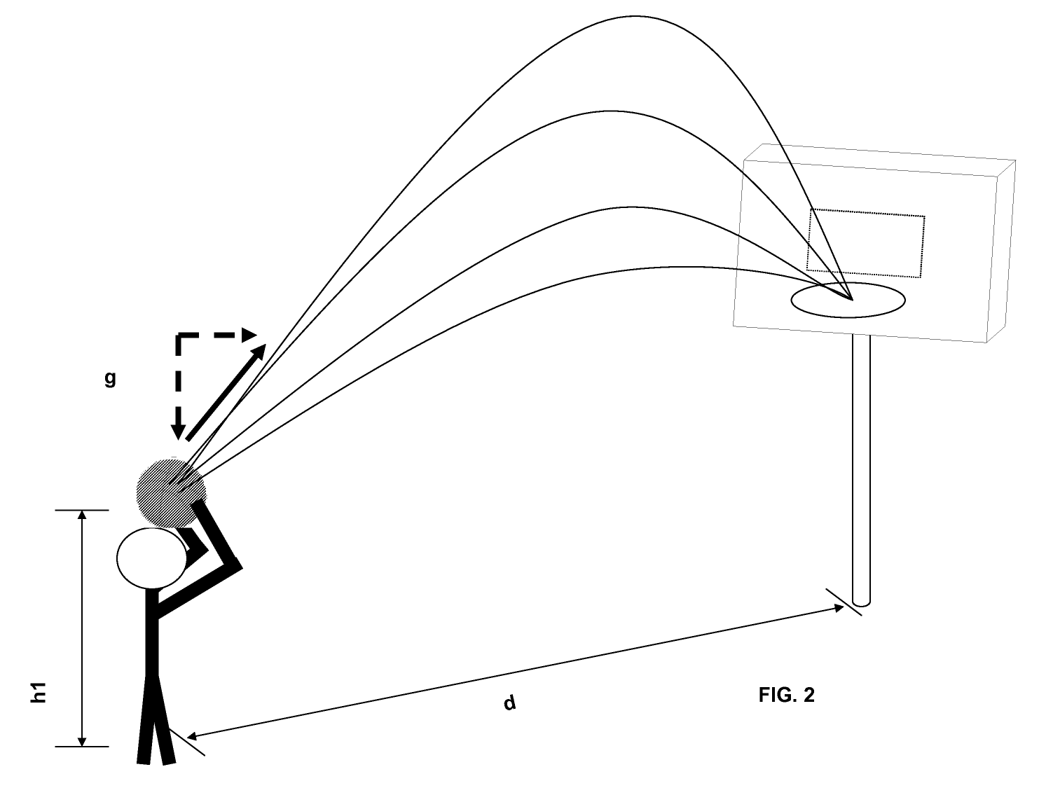

### DETAILED DESCRIPTION

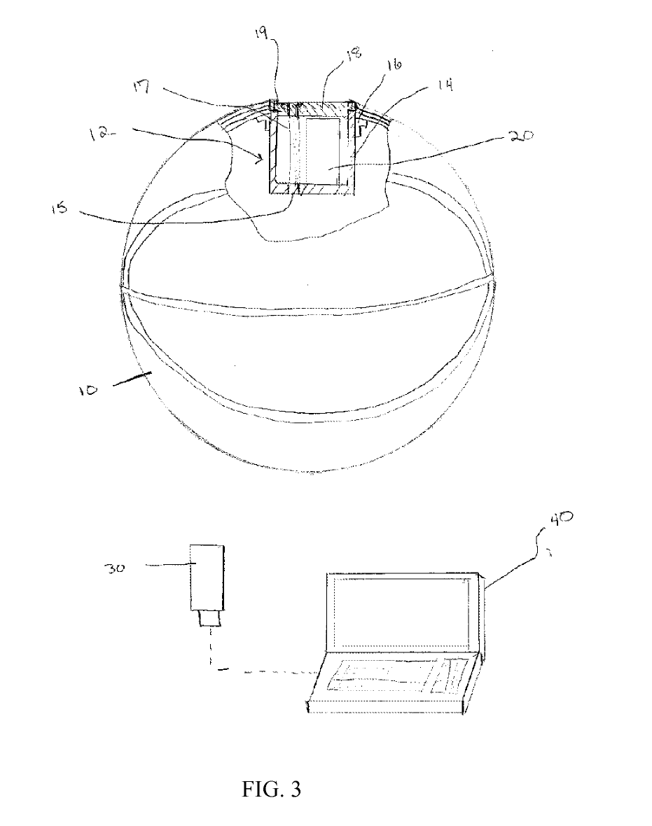

The present invention comprises a device for providing information concerning position and movement of a sports implement, preferably a basketball to a user. As shown in FIG. 3, the device generally comprises a basketball 10, a sensor board 20, a receiver board 30, and a personal computer 40.

The basketball 10 has an opening 12 therein for fixedly receiving a rigid cylinder 14. The rigid cylinder 14 is fixed in position within the basketball by means such as flange 16. The specifics of the connection between the rigid cylinder 14 and basketball 10 are more fully described in United States Patent Application Publication No. US2002/0187866 A1, the subject matter of which is hereby incorporated by reference for descriptive purposes, but which does not constitute the present invention. The rigid cylinder has a open end at the surface of the basketball and a closed end inside the basketball. A cap 18 is provided to selectively cover the open end of the rigid cylinder. According to the present preferred embodiment, a threaded bolt 17 may pass through an opening 19 in the cap 18, and the cap is secured in place by screwing the bolt 17 into a threaded opening 15 in the bottom closed end of the rigid cylinder.

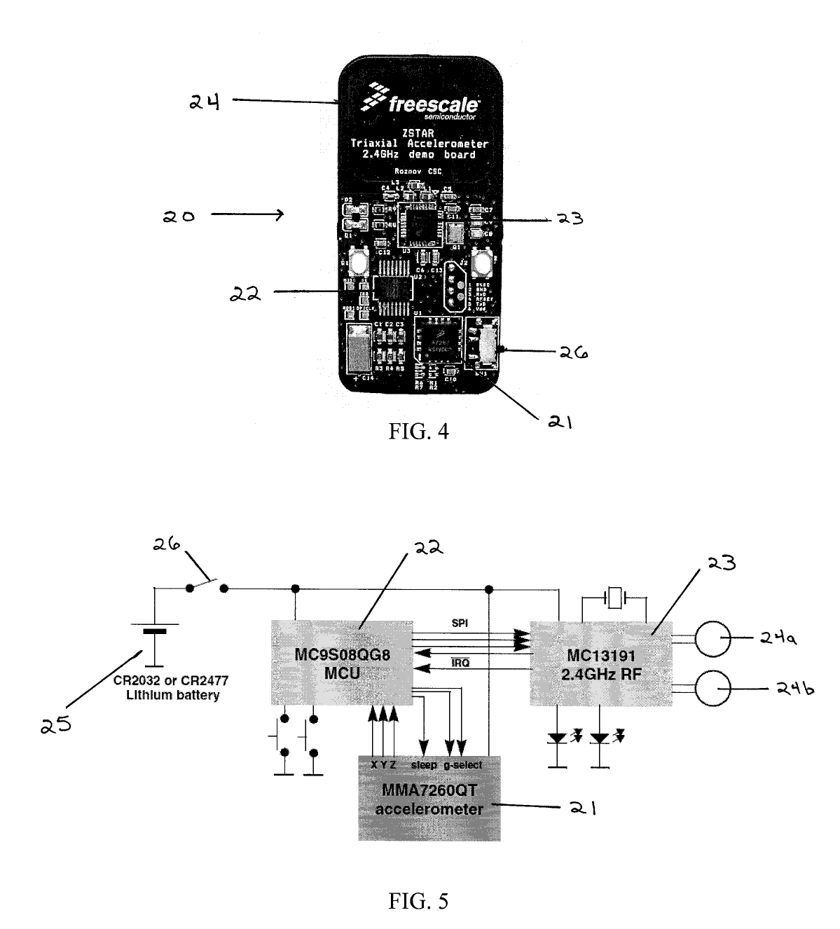

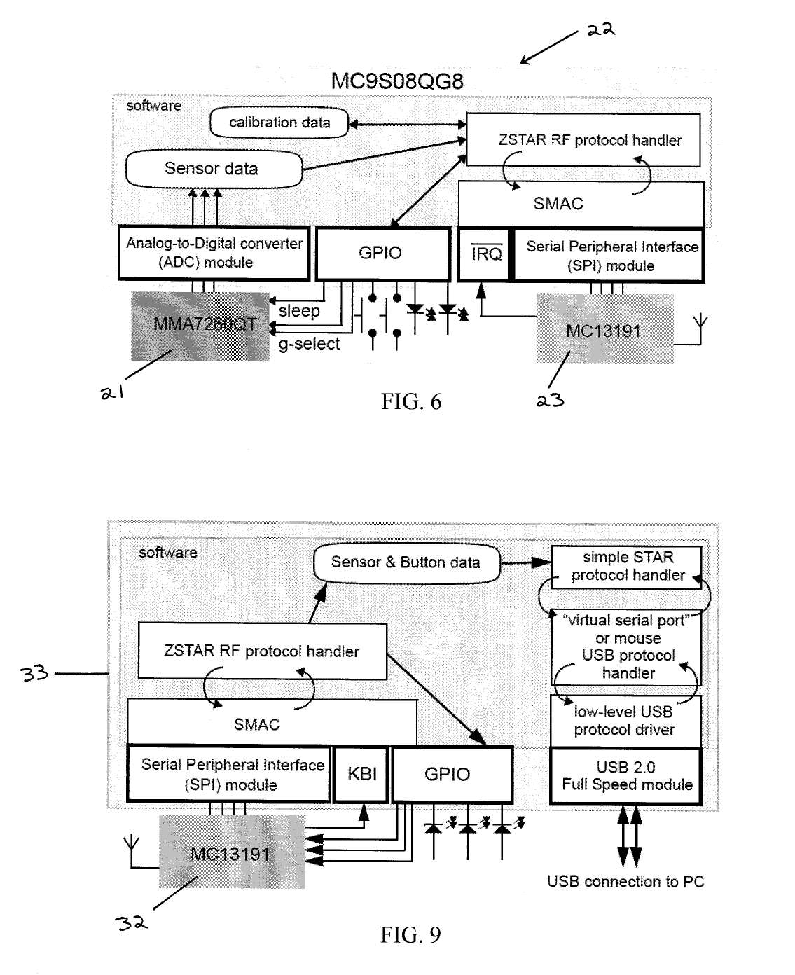

A sensor board 20 is positioned within the rigid cylinder 14. The sensor board preferably utilizes a small footprint size dual-layer printed circuit board (PCB) containing all the necessary circuitry for accelerometer sensing and transferring data over a radio frequency (RF). The main tasks of the sensor board 20 are to measure all three XYZ acceleration values from the sensor, compose a data frame using simple RF protocol, use Simple Media Access Controller (SMAC) to send this data frame over the RF link, and to await acknowledgment from the receiver board. This basic loop repeats roughly 30 times per second providing a nearly real-time response from the sensor. As best shown in FIGS. 4 & 5, the sensor board 20 includes a 3-axis accelerometer 21, a microcontroller 22, transceiver 23 and PCB antennas 24. The sensor board further includes a battery 25 and power switch 26, which are not critical to the present invention. According to one preferred embodiment of the present invention, the 3-axis accelerometer 21 is a low-g accelerometer with selectable 1.5 g to 6 g range. The 3-axis sensing in a small QFN package requires only a 6 mm×6 mm board space, with a profile of 1.45 mm, allowing easy integration into many small handheld electronics. Other derivatives of the 3-axis accelerometer are also contemplated, including the following: XYZ-axis 2.5 g/3.3 g/6.7 g/10 g; XY-axis 1.5 g2 g/4 g/6 g; XY-axis 2.5 g/3.3 g/6.7 g/10 g; XZ-axis 1.5 g/2 g/4 g/6 g; XZ-axis 2.5 g/3.3 g/6.7 g/10 g. The microcontroller 22 is a highly integrated 8-bit microcontroller. The microcontroller may also include a background debugging system and on-chip in-circuit emulation (ICE) with real-time bus capture, providing a singlewire debugging and emulation interface. It also features a programmable 16-bit timer/pulse-width modulation (PWM) module (TPM), that is one of the most flexible and cost-effective of its kind. Features of the microcontroller according to one preferred embodiment include: up to 20 MHz operating frequencies at >2.1 volts and 16 MHz at <2.1 volts; 8 K Flash and 512 bytes RAM; support for up to 32 interrupt/reset sources; 8-bit modulo timer module with 8-bit prescaler; enhanced 8-channel, 10-bit analog-to-digital converter (ADC); analog comparator module; three communication interfaces: SCI, SPI and IIC. The transceiver 23, according to one preferred embodiment of the present invention, is a short range, low power, 2.4 GHz Industrial, Scientific, and Medical (OSM) band transceiver configured to allow for wireless transmission of data. The transceiver 23 contains a complete packet data modem which is compliant with the IEEET 802.15.4 Standard PHY (Physical) layer. This allows the development of proprietary point-to-point and star networks based on the 802.15.4 packet structure and modulation format. Interface between the transceiver 23 and the microcontroller 22 is accomplished using a four wireserial peripheral interface (SPI) connection and an interrupt request output, which allows the use of a variety of processors. The transceiver 23 is electrically coupled to a PCB receiving antenna 24a and a PCB transmitting antenna 24b. According to one preferred embodiment, loop type antenna are used due to the size required on the PC B.

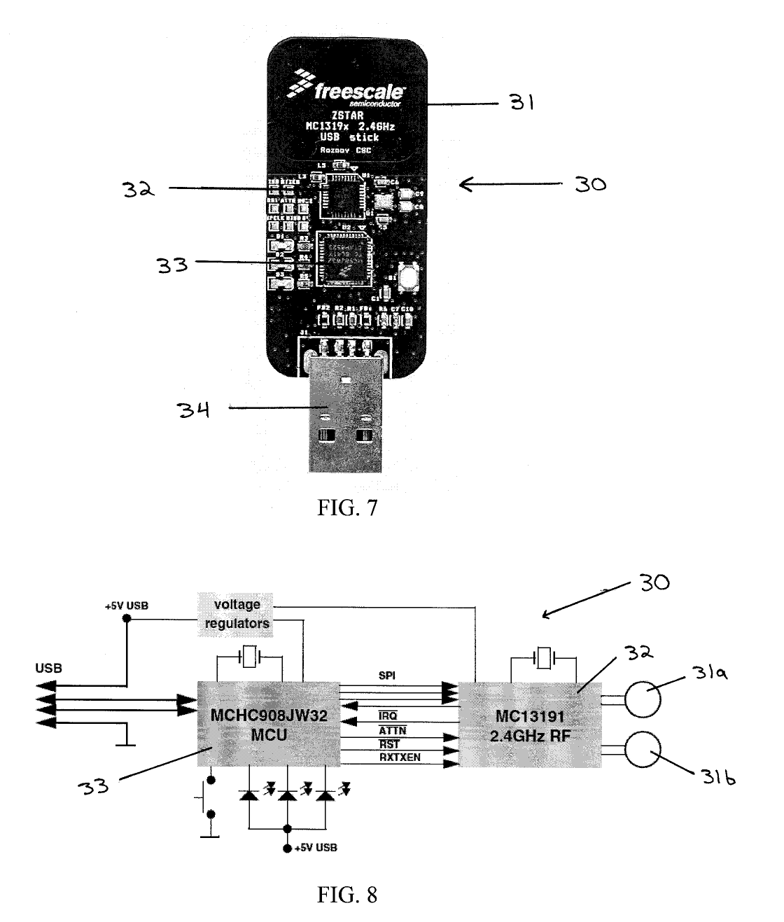

A receiver board 30 is positioned remote from the basketball 10 and is in wireless communication with the sensor board 20 via transceivers 23, 32. The receiver board uses the same small footprint as the sensor board 20, and is also a dual-layer PCB. It contains an RF transceiver 32 connected through an 8-bit microcontroller 33 to a plug 34, such as the USB “A” type plug shown in FIG. 7. Its main tasks are to receive data from the sensor board 20 via transceiver 32 and store the data in a RAM buffer, handle the USB module communication, decode and provide the data from the RAM buffer, and transfer it to the personal computer over the USB link. The RF software communicates with the sensor board 20 and retrieves the latest accelerometer data. That data is stored in RAM and can be independently read by the personal computer application via the USB link. The receiver board transceiver 32 is of the same type as the sensor board transceiver and will not be described in further detail here. Like the sensor board transceiver, the receiver board transceiver is electrically coupled to a receiving PCB antenna 31a, and a transmitting PCB antenna 31b. As best shown in FIGS. 7 & 8, the receiver board transceiver 32 is electrically coupled to a microcontroller 33. According to one preferred aspect of the invention, the microcontroller 33 is an 8-bit microcontroller unit, and is available in a variety of modules, memory sizes and types, and package types. According to a preferred embodiment, the microcontroller 33 features a maximum internal bus frequency of 8 MHz at 3.5-5V operating voltage; a −4 MHz crystal oscillator clock input with 32 MHz internal phase-lock loop; internal 88 kHz RC oscillator for timebase wakeup; 32,768 bytes user program FLASH memory with security feature; 1,024 bytes of on-chip RAM; 29 general-purpose input/output (I/O) ports; 8 keyboard interrupt with internal pull-up (3 pins with direct LED drive, 2 pins with 10 mA current drive for PS/2 connection); 16-bit, 2-channel timer interface module (TIM) with selectable input capture, output compare, PWM capability on each channel, and external clock input option; timebase module; PS/2 clock generator module; Serial Peripheral Interface Module (SPI); and Universal Serial Bus (USB) 2.0 Full Speed functions: 12 Mbps data rate, Endpoint 0 with an 8-byte transmit buffer and an 8-byte receive buffer, and 64 bytes endpoint buffer to share amongst endpoints 1-4.

The present invention also incorporates a method of providing information to the user of a basketball. The height of the shooter, distance from the basket, and height of the basket are first input via the personal computer 40. All three xyz acceleration values are continuously measured by the three-axis accelerometer 21 positioned on the sensor board 20 located within the opening 12 in the basketball 10. The xyz acceleration measurements are sent from the accelerometer 21 to a microcontroller 22 that is electrically connected to the accelerometer 21 and positioned on the sensor board 20. The microcontroller 22 composes data frame using simple RF protocol. Simple media access controller SMAC is then used to send the data frame to a receiving board 30 located remotely from the basketball 10 over an RF link via an RF transceiver 23 electrically connected to the microcontroller 22 and positioned on the sensor board 20. The data frame is received via an RF transceiver 32 positioned on the receiving board 30. The data is then transferred to a personal computer 40 via a plug 34 on the receiving board 30 that is removably connected to said personal computer 40. The data is then decoded and the shooter is provided with information about his or her shot.

The foregoing is provided for purposes of illustrating, explaining, and describing embodiments of the present invention. Further modifications and adaptation to these embodiments will be apparent to those skilled in the art and may be made without departing from the scope or spirit of the invention. It is clear from the description that the particular features and aspects of the present invention are not limited to the sport of basketball and could be utilized in any sport involving a ball where acceleration, velocity and release angle are critical to success. Clearly the concepts of this invention would be equally applicable to other sports involving balls, such as soccer, volleyball, baseball, football, bowling and the like. The present invention is also not intended to be limited to sports applications involving balls, but can potentially be incorporated into any sports implement. As such, the concepts of this invention could also be applied to other sports where velocity, acceleration and release angle are relevant, such as weightlifting, karate and the like.

I claim:

1. A device for providing information concerning position and movement of a sports implement to a user comprising:
a sports implement having an opening therein;
means for sensing the position and acceleration of the sports implement, said sensing means positioned within the opening in the sports implement;
means for transmitting position and acceleration information from the sensing means, said transmitting means positioned within the opening in the sports implement;
means for receiving the position and acceleration information from the transmitting means, said receiving means located at a position remote to the sports implement;
means for integrating the position and acceleration information to approximate velocity and for calculating the end position of the sports implement based on said position and acceleration information; and
means for displaying said calculated data.

2. The device of claim 1, wherein the sensing means and transmitting means are positioned on a sensor board.

3. The device of claim 2, wherein the sensing means comprises a 3-axis low-g accelerometer.

4. The device of claim 3, wherein the accelerometer has a selectable range of between 1.5 g and 6 g.

5. The device of claim 3, wherein the accelerometer is electrically connected to a microprocessor positioned on the sensor board.

6. The device of claim 5, wherein the microprocessor is an 8-bit microprocessor.

7. The device of claim 5, wherein the transmitting means and receiving means each comprise a short range, low power RF transceiver.

8. The device of claim 7, wherein the RF transceivers are 2.4 GHz ISM band transceivers.

9. The device of claim 7, wherein the integrating means comprises a microcontroller electrically connected to the receiving means RF transceiver.

10. The device of claim 9, wherein the microcontroller is electrically connected to a plug which can be connected to a laptop or desktop personal computer.

11. The device of claim 10, wherein the plug is a USB “A” type plug.

12. The device of claim 1, wherein the sports implement is a ball.

13. The device of claim 1, wherein the ball is a basketball.

14. A device for providing information concerning position and movement of a ball to a user comprising:
a ball having an opening therein;
a sensor board positioned within the opening in the ball, said sensor board comprising a three-axis accelerometer electrically connected to a microcontroller and a transceiver;
a receiver board located remotely from the ball, said receiver board comprising transceiver electrically connected to a microcontroller and a plug for connecting to a personal computer.

15. The device of claim 14, wherein the accelerometer has a selectable range of between 1.5 g and 6 g.

16. The device of claim 14, wherein the microprocessor is an 8-bit microprocessor.

17. The device of claim 14, wherein the receiver board transceiver and the sensor board transceiver each comprise a short range, low power RF transceiver.

18. The device of claim 17, wherein the RF transceivers are 2.4 GHz ISM band transceivers.

19. The device of claim 10, wherein the plug is a USB “A” type plug.

20. A method of providing information to the user of a basketball comprising the steps of:
inputting the height of the shooter, distance from the basket, and height of the basket;
continuously measuring all three xyz acceleration values by a three-axis accelerometer positioned on a sensor board located within an opening in the basketball;
sending said xyz acceleration measurements from the accelerometer to a microcontroller that is electrically connected to the accelerometer and positioned on the sensor board;
composing a data frame using simple RF protocol;
using simple media access controller to send said data frame to a receiving board located remotely from the basketball over an RF link via an RF transceiver electrically connected to the microcontroller and positioned on the sensor board;
receiving the data via an RF transceiver positioned on the receiving board;
transmitting said data to a personal computer via a plug on the receiving board that is removably connected to said personal computer;
decoding said data and providing the user with information about his or her shot.
